(19) United States
(12) Patent Application Publication
(10) Pub. No.: US 2009/0068528 A1
(43) Pub. Date: Mar. 12, 2009

(54) HEAT TREATMENT OF PERFLUORINATED IONOMERIC MEMBRANES

(76) Inventor: Mark F. TEASLEY, Landenberg, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/854,005

(22) Filed: Sep. 12, 2007

(51) Int. Cl. H01M 8/10

(52) U.S. Cl. 429/33

(57) ABSTRACT

A process for the conditioning of fully hydrated fluorinated membranes. The hydrated membrane is heated while under pressure, and allowed to cool before the pressure is released.

Disclosed is a process for heat treatment of fluorinated membranes. This invention was made with government support under Contract No. DE-FC04-02AL67606 awarded by the U.S. Department of Energy. The government has certain rights in the invention.

### FIELD OF INVENTION

### Background

Electrochemical cells generally include an anode electrode and a cathode electrode separated by a proton exchange membrane (hereafter “PEM”) used as the electrolyte. A metal catalyst and electrolyte mixture is generally used to form the anode and cathode electrodes. A well-known use of electrochemical cells is in a stack for a fuel cell (a cell that converts fuel and oxidants to electrical energy). In such a cell, a reactant or reducing fluid such as hydrogen or methanol is supplied to the anode, and an oxidant such as oxygen or air is supplied to the cathode. Where the reactant is hydrogen, the hydrogen electrochemically reacts at a surface of the anode to produce hydrogen ions and electrons. The electrons are conducted to an external load circuit and then returned to the cathode, while hydrogen ions transfer through the electrolyte to the cathode, where they react with the oxidant and electrons to produce water and release thermal energy. An individual fuel cell consists of a number of functional components aligned in layers as follows: conductive plate/gas diffusion backing/anode electrode/membrane/cathode electrode/gas diffusion backing/conductive plate. Another well know use of PEM cells is in electrolysis of water to form hydrogen at the cathode and oxygen at the anode.

Most acidic PEMs require substantial water to solvate protons and maintain conductivity, but are poor at retaining sufficient water at temperatures above the boiling point of water. Without sufficient hydration, these PEMs can not maintain adequate conductivity to support fuel cell operation at high temperature (100-200° C.).

Perfluorosulfonic acid membranes apparently retain water better than most other compositions because they typically display higher conductivities at low humidities. However, the resulting conductivities are still deficient for stable fuel cell performance at high power densities. If the water retention of perfluorosulfonic acid membranes could be improved, than the resulting higher conductivities should lead to improved fuel cell performance.

### SUMMARY

Disclosed is a method for conditioning a proton exchange membrane comprising the steps of:
a) providing a fully hydrated membrane comprising a fluorinated sulfonic acid polymer;
b) placing the membrane in a sealed container;
c) heating the membrane to a membrane conditioning temperature greater than about 120° C. and applying a membrane conditioning pressure to the membrane while the membrane is heated to the membrane conditioning temperature, the membrane conditioning pressure being above the steam pressure for the membrane conditioning temperature;
d) cooling the membrane while maintaining the membrane conditioning pressure; and
e) releasing the pressure when the membrane conditioning temperature is below about 100° C.

### BRIEF DESCRIPTION OF DRAWINGS

FIG. 1 is a schematic illustration of the lower fixture of a four-electrode cell for in-plane conductivity measurement.

### DETAILED DESCRIPTION

Where a range of numerical values is recited herein, unless otherwise stated, the range is intended to include the endpoints thereof, and all integers and fractions within the range. It is not intended that the scope of the invention be limited to the specific values recited when defining a range. Moreover, all ranges set forth herein are intended to include not only the particular ranges specifically described, but also any combination of values therein, including the minimum and maximum values recited.

Described herein is a method for the conditioning of a membrane. Typically, conditioning results in a higher level of hydration and improved conductivity when used in electrochemical cells such as fuel cells, especially at higher temperatures and low humidity.

The method comprises the steps of: a) providing a fully hydrated membrane comprising a fluorinated sulfonic acid polymer; b) placing the membrane in a sealed container; c) heating the membrane to a membrane conditioning temperature greater than about 120° C. and applying a membrane conditioning pressure to the membrane while the membrane is heated to the membrane conditioning temperature, the membrane conditioning pressure being above the steam pressure for the membrane conditioning temperature; d) cooling the membrane while maintaining the membrane conditioning pressure; and e) releasing the membrane conditioning pressure when the membrane temperature is below about 100° C.

By “fluorinated sulfonic acid polymer” it is meant a polymer or copolymer with a highly fluorinated backbone and recurring side chains attached to the backbone with the side chains carrying the sulfonic acid group (—SO₃H). The term “highly fluorinated” means that at least 90% of the total number of halogen and hydrogen atoms attached to the polymer backbone and side chains are fluorine atoms. In another embodiment, the polymer is perfluorinated, which means 100% of the total number of halogen and hydrogen atoms attached to the backbone and side chains are fluorine atoms. By “sulfonic acid pendant groups” it is meant groups that are pendant to the polymer backbone as recurring side chains and terminate in a sulfonic acid functionality, SO₃H. The polymer may have small amounts of the acid functionality in the salt or the acid halide form. Typically at least about 8 mol %, more typically at least about 13 mol % or at least about 19% of monomer units have a pendant group with the sulfonic acid functionality.

In another embodiment, the membrane additionally comprises a catalyst coated on at least one side, or both sides, of the membrane to form a catalyst coated membrane (CCM), which are described further herein below. The catalyst can be applied on the membrane either before, during, or after the conditioning treatment described herein. In another embodiment the membrane additionally comprises a gas diffusion electrode on at least one side, or both sides, of the membrane. In another embodiment the membrane is a component of a membrane electrode assembly.

In another embodiment the sulfonic acid polymer is a copolymer of a first fluorinated vinyl monomer and a second fluorinated vinyl monomer containing the sulfonic acid group. Possible first monomers include tetrafluoroethylene (TFE), hexafluoropropylene, vinyl fluoride, vinylidine fluoride, trifluoroethylene, chlorotrifluoroethylene, perfluoro (alkyl vinyl ether)s, and mixtures thereof. Possible second monomers include a variety of fluorinated vinyl ethers containing a sulfonic acid group.

Another embodiment for use in the present invention includes highly fluorinated polymers with a highly fluorinated carbon backbone and a side chain represented by the formula —(O—CF₂CFR_{f})ₐ—(O—CF₂)_{b}—(CFR′_{f})_{c}SO₃OH, where R_{f} and R′_{f} are independently selected from F, Cl or a perfluorinated alkyl group having 1 to 10 carbon atoms, a=0 to 2, b=0 to 1, and c=0 to 6. Suitable homopolymers and copolymers that are known in the art include those described in WO 2000/0024709 and U.S. Pat. No. 6,025,092.

The fluorinated sulfonic acid polymer can be first converted to the sulfonate (SO₃⁻) form from a polymer that contains SO₂X groups (wherein X is a halogen) by hydrolysis using methods known in the art. This is typically done in the membrane form. For example, the polymer containing sulfonyl fluoride groups (SO₂F) may be hydrolyzed to convert it to the sodium sulfonate form by immersing it in 25% by weight NaOH for about 16 hours at a temperature of about 90° C. followed by rinsing the film twice in deionized 90° C. water using about 30 to about 60 minutes per rinse. Another possible method employs an aqueous solution of 6-20% of an alkali metal hydroxide and 5-40% polar organic solvent such as DMSO with a contact time of at least 5 minutes at 50-100° C. followed by rinsing for 10 minutes. After hydrolyzing, the membrane can then be converted to another ionic form at any time by contacting the membrane in a bath containing salt solution of the desired cation. Final conversion to the acid form can be performed by contacting with an acid such as nitric acid and rinsing.

A suitable fluoropolymer or precursor fluoropolymer that is commercially available is Nafion® fluoropolymer from E. I. du Pont de Nemours and Company, Wilmington Del. One type of Nafion® fluoropolymer is a copolymer of tetrafluoroethylene (TFE) with perfluoro(3,6-dioxa-4-methyl-7-octenesulfonyl fluoride) (PSEPVE), as disclosed in U.S. Pat. No. 3,282,875. Other suitable precursor fluoropolymers are copolymers of TFE with perfluoro(3-oxa-4-pentenesulfonyl fluoride) (PSEVE), as disclosed in U.S. Pat. No. 4,358,545 and U.S. Pat. No. 4,940,525, and copolymers of TFE with CF₂═CFO(CF₂)₄SO₂F, as disclosed in U.S. Patent Application 2004/0121210. The precursor polymer can also comprise a perfluorocarbon backbone and a side chain represented by the formula —O—CF₂CF(CF₃)—O—CF₂CF₂SO₂F or —OCF₂CF₂SO₂F. Polymers of this type are disclosed in U.S. Pat. No. 3,282,875 and U.S. Pat. No. 4,358,545 and U.S. Pat. No. 4,940,525.

The polymer can be formed into membranes using any conventional method such as but not limited to extrusion and solution or dispersion film casting techniques. The membrane thickness can be varied as desired for a particular application. Typically, the membrane thickness is less than about 350 μm, more typically in the range of about 10 μm to about 175 μm. If desired, the membrane can be a laminate of two polymers such as two polymers having different equivalent weight. Such films can be made by laminating two membranes. Alternatively, one or both of the laminate components can be cast from solution or dispersion. When the membrane is a laminate, the chemical identities of the monomer units in the additional polymer can independently be the same as or different from the identities of the analogous monomer units of the first polymer. For the purposes of the present invention, the term “membrane,” a term of art in common use is synonymous with the terms “film” or “sheet” which are terms of art in more general usage but refer to the same articles.

The membrane may optionally include a porous support for the purposes of improving mechanical properties, for decreasing cost and/or other reasons. The porous support may be made from a wide range of materials, such as but not limited to non-woven or woven fabrics, using various weaves such as the plain weave, basket weave, leno weave, or others. The porous support may be made from glass, hydrocarbon polymers such as polyolefins, (e.g., polyethylene, polypropylene), or perhalogenated polymers such as polychlorotrifluoroethylene. Porous inorganic or ceramic materials may also be used. For resistance to thermal and chemical degradation, the support preferably is made from a fluoropolymer; most preferably a perfluoropolymer. For example, the perfluoropolymer of the porous support can be a microporous film of polytetrafluoroethylene (PTFE) or a copolymer of tetrafluoroethylene with CF₂═CFCₙF₂ₙ₊₁ (n=1 to 5) or (CF₂═CFO—(CF₂CF(CF₃)O)ₘCₙF₂ₙ₊₁ (m=0 to 15, n=1 to 15). Microporous PTFE films and sheeting are known which are suitable for use as a support layer. For example, U.S. Pat. No. 3,664,915 discloses uniaxially stretched film having at least 40% voids. U.S. Pat. Nos. 3,953,566, 3,962,153 and 4,187,390 disclose porous PTFE films having at least 70% voids. The porous support may be incorporated by coating a polymer dispersion on the support so that the coating is on the outside surfaces as well as being distributed through the internal pores of the support. Alternately or in addition to impregnation, thin membranes can be laminated to one or both sides of the porous support. When the polymer dispersion is coated on a relatively non-polar support such as microporous PTFE film, a surfactant may be used to facilitate wetting and intimate contact between the dispersion and support. The support may be pre-treated with the surfactant prior to contact with the dispersion or may be added to the dispersion itself. Preferred surfactants are anionic fluorosurfactants such as Zonyl® from E. I. du Pont de Nemours and Company, Wilmington Del. A more preferred fluorosurfactant is the sulfonate salt of Zonyl® 1033D.

By “fully hydrated” it is meant that the membrane contains substantially the maximum amount of water that it is possible for it to contain under atmospheric pressure. The membrane can be hydrated by any known means, but typically by soaking it in an aqueous solution at temperatures above room temperature and up to 100° C. Typically the aqueous solution is an acidic solution, such as 10% to 15% aqueous nitric acid, optionally followed by pure water washes to remove excess acid. The soaking should be performed for at least 15 minutes, more typically for at least 30 minutes, and at above 60° C., more typically above 80° C., until the membrane is fully hydrated at atmospheric pressures.

Next the hydrated membrane is placed in a sealed container. By “sealed” it is meant that the container is impervious to water, water vapor and oxygen. Pressure and heat are applied in any order or simultaneously; that is, the heat can be applied first followed by the pressure, the pressure can be applied first followed by the heat, or both may be applied at the same time. The temperature of the heated membrane, also called the membrane conditioning temperature, should be above the alpha relaxation temperature for the membrane. The alpha relaxation is the first (highest) thermal transition seen in dynamic mechanical analysis (DMA), while the beta is next lowest, followed by the gamma relaxation as the lowest. For Nafion® membrane, the alpha relaxation is due to the onset of long-range mobility of the polymer backbone and side chains within a dynamic ionic network due to weakening of and movement of side chains between the ionic clusters. The beta relaxation is the true T_{g} and is due to the onset of mobility of the polymer backbone and side chains within a static ionic network (see R. B. Moore et al. Macromolecules, 2005, 38, 6472-6484.) For the membranes suitable for the present process the membrane conditioning temperature would typically be above about 120° C., more typically above about 150° C. The upper limit for the temperature should be below the temperature at which the polymer starts to degrades but is typically about 250° C., more typically 225° C.

The pressure can be applied to the membrane in any suitable manner including direct pressure or indirect pressure. By direct pressure it is meant that the pressure is applied by mechanical means such as but not limited to a hydraulic press. Indirect pressure can be applied by a pressurized fluid (liquid or gas), including hydraulic presses coupled with sealed cavities, autoclaves or similar apparatus. The pressure applied to the membrane during conditioning, also called the membrane conditioning pressure, should be greater than the saturated steam pressure for the desired membrane conditioning temperature of the membrane, that is, should be greater than the minimum pressure needed to maintain the water in the liquid state at the temperature used. The saturated steam pressure for various temperatures is readily available in many reference books, such as the Handbook of Chemistry and Physics, CRC Press. When the membrane conditioning temperature of the membrane is above about 120° C., the membrane conditioning pressure would therefore be at least about 29 psia (200 KPa). When the temperature of the membrane is above about 150° C., the pressure would be at least about 69 psia (475 KPa).

The duration of the heat and pressure treatment is not critical but is typically at least 2 minutes before the membrane is allowed to cool. The membrane can be cooled by any method, such as chilled water, but typically is allowed to cool in ambient conditions. The container must be kept sealed during the cooling step in order to maintain the membrane conditioning pressure and prevent the evaporation of water from the membrane. Some pressure drop may occur due to the temperature decrease.

After the membrane has cooled to below about 100° C., or more typically 50° C., the pressure can be released and the membrane can be utilized in any application.

The membranes and catalyst coated membranes described herein can be used in conjunction with fuel cells utilizing proton exchange membranes (also known as “PEM”). Examples include hydrogen fuel cells, reformed-hydrogen fuel cells, direct methanol fuel cells or other organic/air (e.g. those utilizing organic fuels of ethanol, propanol, dimethyl- or diethyl ethers, formic acid, carboxylic acid systems such as acetic acid, and the like). The membranes are also advantageously employed in MEAs for electrochemical cells. Other uses for the membranes and processes described herein include batteries and other types of electrochemical cells and for use in cells for the electrolysis of water to form hydrogen and oxygen.

Fuel cells are typically formed as stacks or assemblages of membrane electrode assemblies (MEAs), which each include a PEM, an anode electrode and cathode electrode, and other optional components. The fuel cells typically also comprise a porous electrically conductive sheet material that is in electrical contact with each of the electrodes and permits diffusion of the reactants to the electrodes, and is known as a gas diffusion layer, gas diffusion substrate or gas diffusion backing. When a catalyst, also known as an electrocatalyst, is coated on or applied to the PEM, the MEA is said to include a catalyst coated membrane (CCM). In other instances, fuel cells may comprise a CCM in combination with a gas diffusion backing (GDB) to form an unconsolidated MEA. Fuel cells may also comprise a membrane in combination with gas diffusion electrodes (GDE), that may or may not have catalyst incorporated within, to form a consolidated MEA.

A fuel cell is constructed from a single MEA or multiple MEAs stacked in series by further providing porous and electrically conductive anode and cathode gas diffusion backings, gaskets for sealing the edge of the MEAs, which also provide an electrically insulating layer, current collector blocks such as graphite plates with flow fields for gas distribution, end blocks with tie rods to hold the fuel cell together, an anode inlet and outlet for fuel such as hydrogen, a cathode gas inlet, and outlet for oxidant such as air.

MEAs and fuel cells therefrom are well known in the art. One suitable embodiment is described herein. An ionomeric polymer membrane is used to form a MEA by combining it with a catalyst layer, comprising a catalyst such as platinum, which is unsupported or supported on particles such as carbon particles, a proton-conducting binder such as Nafion® polymer, and a gas diffusion backing. The catalyst layers may be made from well-known electrically conductive, catalytically active particles or materials and may be made by methods well known in the art. The catalyst layer may be formed as a film of a polymer that serves as a binder for the catalyst particles. The binder polymer can be a hydrophobic polymer, a hydrophilic polymer or a mixture of such polymers. The binder polymer is typically ionomeric and can be the same ionomer as in the membrane.

The catalyst layer may be applied from a catalyst paste or ink onto an appropriate substrate for incorporation into an MEA. The method by which the catalyst layer is applied is not critical to the practice of the present invention. Known catalyst coating techniques can be used and produce a wide variety of applied layers of essentially any thickness ranging from very thick, e.g., 30 μm or more, to very thin, e.g., 1 μm or less. Typical manufacturing techniques involve the application of the catalyst ink or paste onto either the polymer exchange membrane or a gas diffusion substrate. Additionally, electrode decals can be fabricated and then transferred to the membrane or gas diffusion backing layers. Methods for applying the catalyst onto the substrate include spraying, painting, patch coating and screen printing or flexographic printing. Preferably, the thickness of the anode and cathode electrodes ranges from about 0.1 to about 30 microns, more preferably less than 25 micron. The applied layer thickness is dependent upon compositional factors as well as the process used to generate the layer. The compositional factors include the metal loading on the coated substrate, the void fraction (porosity) of the layer, the amount of polymer/ionomer used, the density of the polymer/ionomer, and the density of the carbon support. The process used to generate the layer (e.g. a hot pressing process versus a painted on coating or drying conditions) can affect the porosity and thus the thickness of the layer.

In a preferred embodiment, a catalyst coated membrane is formed wherein thin electrode layers are attached directly to opposite sides of the proton exchange membrane. In one method of preparation, the electrode layer is prepared as a decal by spreading the catalyst ink on a flat release substrate such as Kapton® polyimide film (available from the DuPont, Wilmington, Del.). The decal is transferred to the surface of the membrane by the application of pressure and optional heat, followed by removal of the release substrate to form a CCM with a catalyst layer having a controlled thickness and catalyst distribution. The decal can be applied to the surface of the membrane during the process of the invention, especially during step c) of the process described herein. The membrane is preferably wet at the time that the electrode decal is transferred to the membrane. Alternatively, the catalyst ink may be applied directly to the membrane, such as by printing, after which the catalyst film is dried at a temperature not greater than 200° C. The CCM, thus formed, is then combined with a gas diffusion backing substrate to form an unconsolidated MEA.

Another method is to first combine the catalyst ink with a gas diffusion backing substrate, and then, in a subsequent thermal consolidation step, with the proton exchange membrane. This consolidation may be performed simultaneously with consolidation of the MEA at a temperature no greater than 200° C., preferably in the range of 140-160° C. The consolidation may be performed during the process of the invention, especially during step c) of the process described herein. The gas diffusion backing comprises a porous, conductive sheet material such as paper or cloth, made from a woven or non-woven carbon fiber, that can optionally be treated to exhibit hydrophilic or hydrophobic behavior, and coated on one or both surfaces with a gas diffusion layer, typically comprising a film of particles and a binder, for example, fluoropolymers such as PTFE. Gas diffusion backings for use in accordance with the present invention as well as the methods for making the gas diffusion backings are those conventional gas diffusion backings and methods known to those skilled in the art. Suitable gas diffusion backings are commercially available, including for example, Zoltek® carbon cloth (available from Zoltek Companies, St. Louis, Mo.) and ELAT® (available from E-TEK Incorporated, Natick, Mass.).

### EXAMPLES

### Through-Plane Conductivity Measurement

The through-plane conductivity of a membrane was measured by a technique in which the current flowed perpendicular to the plane of the membrane. The lower electrode was formed from a 12.7 mm diameter stainless steel rod and the upper electrode was formed from a 6.35 mm diameter stainless steel rod. The rods were cut to length, and their ends were polished and plated with gold. A stack was formed consisting of lower electrode/GDE/membrane/GDE/upper electrode. The GDE (gas diffusion electrode) was a catalyzed ELAT® (E-TEK Division, De Nora North America, Inc., Somerset, N.J.) comprising a carbon cloth with microporous layer, platinum catalyst, and 0.6-0.8 mg/cm² Nafion® polymer applied over the catalyst layer. The lower GDE was punched out as a 9.5 mm diameter disk, while the membrane and the upper GDE were punched out as 6.35 mm diameter disks to match the upper electrode. The stack was assembled and held in place within a block of Macor® machinable glass ceramic (Corning Inc., Corning, N.Y.) that had a 12.7 mm diameter hole drilled into the bottom of the block to accept the lower electrode and a concentric 6.4 mm diameter hole drilled into the top of the block to accept the upper electrode. A force of 270 N was applied to the stack by means of a clamp and calibrated spring. This produced a pressure of 8.6 MPa in the active area under the upper electrode, which insured a low impedance ionic contact between the GDE's and the membrane. The fixture was placed inside a forced-convection thermostated oven for heating. The real part of the AC impedance of the fixture containing the membrane, R_{f}, was measured at a frequency of 100 kHz using a potentiostat/frequency response analyzer (PC4/750™ with EIS software, Gamry Instruments, Warminster, Pa.). The fixture short, R_{f}, was also determined by measuring the real part of the AC impedance at 100 kHz for the fixture and stack assembled without a membrane sample. The conductivity, K, of the membrane was then calculated as

κ=t/((Rₛ−R_{f})×0.317 cm²),

where t was the thickness of the membrane in cm.

### In-Plane Conductivity Measurement

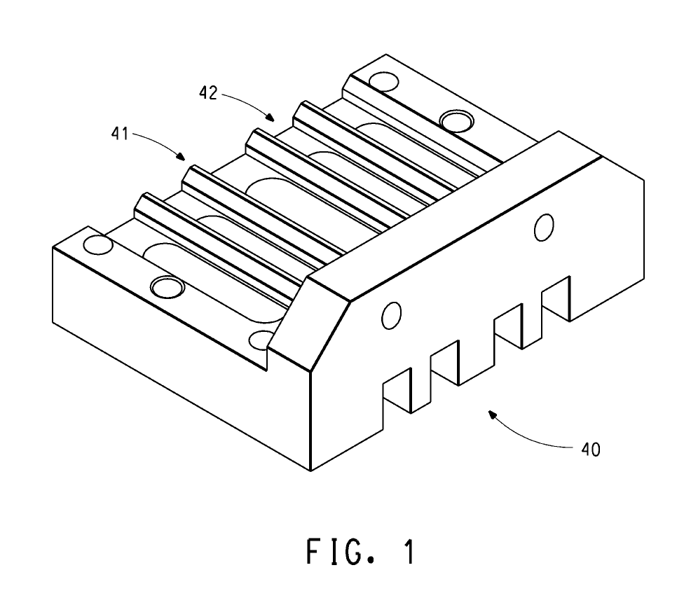

The in-plane conductivity of a membrane is measured under conditions of controlled relative humidity and temperature by a technique in which the current flows parallel to the plane of the membrane. A four-electrode technique is used similar to that described in an article entitled “Proton Conductivity of Nafion® 117 As Measured by a Four-Electrode AC Impedance Method” by Y. Sone et al., J. Electrochem. Soc., Vol. 143, 1254 (1996), which is herein incorporated by reference. Referring to FIG. 1, a lower fixture (40) is machined from annealed glass-fiber reinforced PEEK to have four parallel ridges (41) containing grooves that support and hold four 0.25 mm diameter platinum wire electrodes. The distance between the two outer electrodes is 25 mm, while the distance between the two inner electrodes is 10 mm. A strip of membrane is cut to a width between 10 and 15 mm and a length sufficient to cover and extend slightly beyond the outer electrodes, and placed on top of the platinum electrodes. An upper fixture (not shown), which has ridges corresponding in position to those of the bottom fixture, is placed on top and the two fixtures are clamped together so as to push the membrane into contact with the platinum electrodes. The fixture containing the membrane is placed in a small pressure vessel (pressure filter housing), which is placed in a forced-convection thermostated oven for heating. The temperature within the vessel is measured by means of a thermocouple. Water is fed from a calibrated Waters 515 HPLC pump (Waters Corporation, Milford, Mass.) and combined with dry air fed from a calibrated mass flow controller (200 sccm maximum) to evaporate the water within a coil of 1.6 mm diameter stainless steel tubing inside the oven. The resulting humidified air is fed into the inlet of the pressure vessel. The total pressure within the vessel (100 to 345 kPa) is adjusted by means of a pressure-control let-down valve on the outlet and measured using a capacitance manometer (Model 280E, Setra Systems, Inc., Boxborough, Mass.). The relative humidity is calculated assuming ideal gas behavior using tables of the vapor pressure of liquid water as a function of temperature, the gas composition from the two flow rates, the vessel temperature, and the total pressure. Referring to FIG. 1, the slots (42) in the lower and upper parts of the fixture allow access of humidified air to the membrane for rapid equilibration with water vapor. Current is applied between the outer two electrodes while the resultant voltage is measured between the inner two electrodes. The real part of the AC impedance (resistance) between the inner two electrodes, R, is measured at a frequency of 1 kHz using a potentiostat/frequency response analyzer (PC4/750™ with EIS software, Gamry Instruments, Warminster, Pa.). The conductivity, K, of the membrane is then calculated as

κ=1.00 cm/(R×t×w),

where t is the thickness of the membrane and w is its width (both in cm).

### Example 1

A stock sheet of Nafion® N117 membrane (E. I. DuPont de Nemours, Inc., Wilmington, Del.) was cut into four 3″×3″ squares. The squares were treated with 15% nitric acid for 30 minutes at a mild reflux. The squares were then washed twice with deionized water for 30 minutes at a reflux. The fully hydrated membrane squares were stored in deionized water.

For heat treatment, a square was removed from water and cut into four equal square pieces. Each piece was placed between two pieces of Teflon-coated polished aluminum foil, which were slightly larger in size, followed by two ⅛″ thick sheets of high-temperature silicon rubber, which completely sealed the fully hydrated membrane sample inside, and two 1/16″ rigid steel plates. This assembly was placed into a heated hydraulic press equilibrated to the required temperature as shown in Table 1 and pressed under 10,000 lb of force to maintain the internal pressure above the steam pressure for the respective temperatures. The assembly was held at temperature for 30 minutes then cooled to 50° C. under ambient conditions before removing from the press.

The heat-treated membrane samples were retreated with 15% nitric acid and deionized water as described above, and stored in water until measured for in-plane conductivity under the conditions of relative humidity and temperature as shown in Table 1. The membrane samples were measured for thickness after the conductivity measurements and used in their calculation.

TABLE 1

| Heat-Treatment | In-Plane Conductivity | | | |
|---|---|---|---|---|
| Temperature, ° C. | | 80° C. | 120° C. | Thickness |
| (Steam Pressure, psia) | RH % | mS/cm | mS/cm | microns |
| Control | 25 | 8.9 | 7.6 | 172 |
| | 50 | 36.1 | 44.0 | |
| | 95 | 188.1 | 228.5 | |
| 150 | 25 | 10.3 | 6.7 | 170 |
| (69) | 50 | 45.9 | 52.3 | |
| | 95 | 316.3 | 273.4 | |
| 175 | 25 | 10.9 | 9.2 | 158 |
| (129) | 50 | 46.1 | 57.6 | |
| | 95 | 272.5 | 299.7 | |
| 200 | 25 | 12.4 | 10.1 | 159 |
| (226) | 50 | 46.0 | 48.6 | |
| | 95 | 293.6 | 272.5 | |
| 225 | 25 | 11.5 | 11.6 | 164 |
| (370) | 50 | 57.5 | 46.4 | |
| | 95 | 297.2 | 273.0 | |

### Example 2

The procedure of Example 1 was used to hydrate Nafion® N117 membrane squares for heat treatment.

For heat treatment, each piece was placed between two pieces of Teflon-coated polished aluminum foil, which were slightly larger in size. This was placed inside a cavity cut into a ⅛″ thick sheet of high-temperature silicon rubber that was between two ⅛″ thick sheets of high-temperature silicon rubber, which sealed the fully hydrated membrane sample inside. The rubber sheets were placed between two 1/16″ rigid steel plates. This assembly was placed into a heated hydraulic press equilibrated to the required temperature as shown in Table 2 and pressed under 10,000 lb of force to maintain the internal pressure above the steam pressure for the respective temperatures. The assembly was held at temperature for 30 minutes then cooled to 50° C. before removing from the press.

The heat-treated membrane samples were retreated with 15% nitric acid and deionized water as described above, and stored in water until measured for in-plane conductivity under the conditions of relative humidity and temperature as shown in Table 2. The membrane samples were measured for thickness after the conductivity measurements and used in their calculation.

TABLE 2

| Heat-Treatment | In-Plane Conductivity | | | |
|---|---|---|---|---|
| Temperature, ° C. | | 80° C. | 120° C. | Thickness |
| (Steam Pressure, psia) | RH % | mS/cm | mS/cm | microns |
| Control | 25 | 6.8 | 7.4 | 171 |
| | 50 | 29.5 | 49.9 | |
| | 95 | 193.5 | 227.6 | |
| 200 | 25 | 7.0 | 10.5 | 183 |
| (226) | 50 | 41.4 | 47.7 | |
| | 95 | 254.4 | 269.7 | |
| 225 | 25 | 14.4 | 10.3 | 164 |
| (370) | 50 | 79.3 | 59.0 | |
| | 95 | 354.8 | 338.9 | |
| 250 | 25 | 12.4 | 10.1 | 122 |
| (577) | 50 | 51.5 | 46.2 | |
| | 95 | 230.9 | 257.6 | |

### Example 3

The procedure of Example 1 was used to heat-treat membrane squares of Nafion® (EW 1542, 8 mil thick) at the temperatures indicated in Table 3. The membrane samples were measured for in-plane conductivity under the conditions of relative humidity and temperature as shown in Table 3. The membrane samples were measured for thickness after the conductivity measurements and used in their calculation.

TABLE 3

| Heat-Treatment | In-Plane Conductivity | | | |
|---|---|---|---|---|
| Temperature | | 80° C. | 120° C. | Thickness |
| ° C. | RH % | mS/cm | mS/cm | microns |
| Control | 25 | 0.6 | 0.8 | 183 |
| | 50 | 4.3 | 5.2 | |
| | 95 | 47.2 | 54.4 | |
| 200 | 25 | 1.1 | 2.3 | 186 |
| | 50 | 10.8 | 12.3 | |
| | 95 | 58.3 | 83.7 | |
| 250 | 25 | 2.6 | 1.7 | 153 |
| | 50 | 12.8 | 10.6 | |
| | 95 | 71.1 | 84.9 | |

### Example 4

The procedure of Example 1 was used to heat-treat membrane squares of Nafion® (reinforced with expanded micro-porous PTFE membrane) under 5000 lb of force to maintain the internal pressure above the steam pressure for the respective temperatures indicated in Table 4. The membrane samples were measured for in-plane conductivity under the conditions of relative humidity and temperature as shown in Table 4. The membrane samples were measured for thickness after the conductivity measurements and used in their calculation.

TABLE 4

| Heat-Treatment | In-Plane Conductivity | | | |
|---|---|---|---|---|
| Temperature | | 80° C. | 120° C. | Thickness |
| ° C. | RH % | mS/cm | mS/cm | microns |
| Control | 25 | 0.9 | 1.5 | 19 |
| | 50 | 15.6 | 15.2 | |
| | 95 | 129.5 | 142.0 | |
| 200 | 25 | 2.6 | 2.1 | 28 |
| | 50 | 14.9 | 12.3 | |
| | 95 | 85.3 | 81.7 | |
| 225 | 25 | 8.5 | 5.9 | 17 |
| | 50 | 42.9 | 28.2 | |
| | 95 | 147.9 | 144.8 | |

### Example 5

The procedure of Example 1 was used to heat-treat membrane squares (4 cm×4 cm) of a perfluorosulfonic acid made from the copolymer of TFE with PSEVE (EW 820, 4 mil thick) under 5000 lb of force to maintain the internal pressure above the steam pressure for the respective temperatures indicated in Table 5. The membrane samples were measured for in-plane conductivity under the conditions of relative humidity and temperature as shown in Table 5. The membrane samples were measured for thickness after the conductivity measurements and used in their calculation.

TABLE 5

| | |
|---|---|
| Heat- | In-Plane |
| Treatment | Conductivity |

| Temperature | Relative | 80° C. | 120° C. | Thickness |
|---|---|---|---|---|
| ° C. | Humidity % | mS/cm | mS/cm | microns |
| Control | 25 | 10.4 | 9.2 | 107 |
| | 50 | 48.0 | 50.0 | |
| | 95 | 257.4 | 317.4 | |
| 175 | 25 | 17.8 | 19.0 | 114 |
| | 50 | 76.3 | 75.0 | |
| | 95 | 376.5 | 402.4 | |
| 200 | 25 | 16.8 | 14.4 | 113 |
| | 50 | 75.6 | 79.9 | |
| | 95 | 370.7 | 448.7 | |
| 225 | 25 | 9.6 | 11.7 | 86 |
| | 50 | 56.1 | 77.5 | |
| | 95 | 319.6 | 427.5 | |
| 250 | 25 | 10.3 | 12.7 | 98 |
| | 50 | 52.2 | 63.8 | |
| | 95 | 333.3 | 376.6 | |

The membrane samples were measured for through-plane conductivity at room temperature as shown in Table 6. The circuit resistance was measured to be 0.05853 ohms. The heat-treated samples showed higher conductivity than the control.

TABLE 6

| | | Total | Through-Plane |
|---|---|---|---|
| Sample | Thickness | Resistance | Conductivity |
| Description | microns | ohms | mS/cm |
| Control | 136 | 0.47123 | 104.0 |
| 175° C. | 146 | 0.36370 | 150.9 |
| 200° C. | 164 | 0.33252 | 188.8 |
| 225° C. | 124 | 0.36026 | 129.6 |
| 250° C. | 127 | 0.36473 | 130.6 |

The durability of the conductivity improvement for the membrane sample that was heat-treated at 175° C. was tested versus the control sample. Each was cycled through the in-plane conductivity measurement on four consecutive days as shown in Table 7. No degradation was observed in the conductivity of either sample with the heat-treated sample retaining its advantage versus the control.

TABLE 7

In-Plane
Conductivity

| Cycle | Relative | 80° C. | 120° C. | Thickness |
|---|---|---|---|---|
| (Sample) | Humidity % | mS/cm | mS/cm | microns |
| 1^{st} Day | 25 | 8.4 | 8.8 | 106 |
| (Control) | 50 | 45.0 | 47.0 | |
| | 95 | 263.4 | 338.0 | |
| 2^{nd} Day | 25 | 9.6 | 11.4 | 106 |
| (Control) | 50 | 51.2 | 51.7 | |
| | 95 | 268.7 | 335.7 | |
| 3^{rd} Day | 25 | 10.0 | 12.3 | 106 |
| (Control) | 50 | 47.9 | 50.0 | |
| | 95 | 277.9 | 332.1 | |
| 4^{th} Day | 25 | 9.3 | 10.0 | 106 |
| (Control) | 50 | 52.1 | 49.3 | |
| | 95 | 267.1 | 334.2 | |
| 1^{st} Day | 25 | 22.5 | 16.0 | 107 |
| (175° C.) | 50 | 84.8 | 75.0 | |
| | 95 | 421.0 | 441.7 | |
| 2^{nd} Day | 25 | 18.6 | 14.7 | 107 |
| (175° C.) | 50 | 70.2 | 77.2 | |
| | 95 | 387.3 | 434.0 | |
| 3^{rd} Day | 25 | 13.5 | 16.6 | 107 |
| (175° C.) | 50 | 63.0 | 64.4 | |
| | 95 | 367.7 | 420.8 | |
| 4^{th} Day | 25 | 13.1 | 15.8 | 107 |
| (175° C.) | 50 | 61.9 | 71.2 | |
| | 95 | 366.9 | 427.4 | |

### Example 6

The procedure of Example 1 was used to heat-treat membrane squares (4 cm×4 cm) of Nafion® N112 under 5000 lb of force to maintain the internal pressure above the steam pressure for the respective temperatures indicated in Table 5. The membrane samples were measured for in-plane conductivity under the conditions of relative humidity and temperature as shown in Table 8. The membrane samples were measured for thickness after the conductivity measurements and used in their calculation.

TABLE 8

| | |
|---|---|
| Heat- | In-Plane |
| Treatment | Conductivity |

| Temperature | Relative | 80° C. | 120° C. | Thickness |
|---|---|---|---|---|
| ° C. | Humidity % | mS/cm | mS/cm | microns |
| Control | 25 | 6.5 | 7.7 | 55 |
| | 50 | 24.3 | 32.2 | |
| | 95 | 128.8 | 158.9 | |
| 150 | 25 | 10.6 | 11.5 | 58 |
| | 50 | 44.5 | 48.5 | |
| | 95 | 213.7 | 226.4 | |
| 175 | 25 | 11.7 | 13.6 | 54 |
| | 50 | 48.2 | 62.2 | |
| | 95 | 206.2 | 263.0 | |
| 200 | 25 | 13.9 | 14.1 | 60 |
| | 50 | 55.0 | 55.1 | |
| | 95 | 215.3 | 244.4 | |
| 225 | 25 | 12.7 | 13.9 | 48 |
| | 50 | 56.3 | 57.2 | |
| | 95 | 238.3 | 259.2 | |

### Example 7

The procedure of Example 2 was used to heat-treat membrane squares (4 cm×4 cm) of Nafion® N112 at the temperatures indicated in Table 5 using a cavity that was 5 cm×5 cm in size. The membrane samples were measured for in-plane conductivity under the conditions of relative humidity and temperature as shown in Table 9. The membrane samples were measured for thickness after the conductivity measurements and used in their calculation.

TABLE 9

| | |
|---|---|
| Heat- | In-Plane |
| Treatment | Conductivity |

| Temperature | Relative | 80° C. | 120° C. | Thickness |
|---|---|---|---|---|
| ° C. | Humidity % | mS/cm | mS/cm | microns |
| Control | 25 | 5.3 | 7.4 | 69 |
| | 50 | 25.6 | 28.3 | |
| | 95 | 109.7 | 124.4 | |
| 150 | 25 | 7.7 | 8.1 | 63 |
| | 50 | 31.7 | 33.8 | |
| | 95 | 148.3 | 152.4 | |
| 175 | 25 | 12.0 | 10.7 | 61 |
| | 50 | 52.1 | 47.9 | |
| | 95 | 217.9 | 222.5 | |
| 200 | 25 | 9.3 | 11.4 | 57 |
| | 50 | 41.3 | 39.8 | |
| | 95 | 170.7 | 181.1 | |
| 225 | 25 | 11.8 | 10.3 | 53 |
| | 50 | 41.6 | 40.3 | |
| | 95 | 160.1 | 180.3 | |

### Example 8

A stock sheet of Nafion® N112 membrane was cut into four 4″×4″ squares. The squares were treated with 15% nitric acid for 30 minutes at a mild reflux. The squares were then washed twice with deionized water for 30 minutes at a reflux. The fully hydrated membrane squares were stored in deionized water.

For heat treatment, each square was removed from water and placed between two pieces of Teflon-coated polished aluminum foil that were 4″×4″ in size. The foil package was placed between two 1/16″ thick sheets of high-temperature silicon rubber that were 5″×5″ in size, which completely sealed the fully hydrated membrane samples inside, followed by two 1/16″ rigid steel plates. This assembly was placed into a heated hydraulic press equilibrated to 200° C. and pressed under 6000 lb of force to maintain the minimum internal pressure (240 psig) above the steam pressure for 200° C. (226 psia). The assembly was held at temperature for 30 minutes then cooled to 50° C. before removing from the press.

The heat-treated membrane samples were retreated with 15% nitric acid and deionized water as described above, and stored in water. A membrane sample was used to measure in-plane conductivity under the conditions of relative humidity and temperature as shown in Table 10. The membrane samples were measured for thickness after the conductivity measurements and used in their calculation.

TABLE 10

| | |
|---|---|
| Heat- | In-Plane |
| Treatment | Conductivity |

| Temperature | Relative | 80° C. | 120° C. | Thickness |
|---|---|---|---|---|
| ° C. | Humidity % | mS/cm | mS/cm | microns |
| Control | 25 | 7.9 | 9.2 | 53 |
| | 50 | 33.8 | 39.0 | |
| | 95 | 156.2 | 178.2 | |
| 200° C. | 25 | 16.3 | 14.2 | 43 |
| | 50 | 82.9 | 67.3 | |
| | 95 | 305.5 | 303.6 | |

### Comparative Example 1

A stock sheet of Nafion® N112 membrane was cut into five 4″×4″ squares. The squares were treated with 15% nitric acid for 30 minutes at a mild reflux. The squares were then washed twice with deionized water for 30 minutes at a reflux. The fully hydrated membrane squares were stored in deionized water.

For heat treatment, four squares were removed from water and distributed evenly between two pieces of Teflon-coated polished aluminum foil that were 10″×10″ in size. The foil package was placed between two 1/16″ thick sheets of high-temperature silicon rubber that were 12″×14″ in size, which completely sealed the fully hydrated membrane samples inside, followed by two 1/16″ rigid steel plates. This assembly was placed into a heated hydraulic press equilibrated to 225° C. and pressed under 5000 lb of force, which maintained the internal pressure (30-78 psig) below the steam pressure for 225° C. (370 psia). The assembly was held at temperature for 30 minutes then cooled to 50° C. before removing from the press.

The heat-treated membrane samples were retreated with 15% nitric acid and deionized water as described above, and stored in water. A membrane sample was used to measure in-plane conductivity under the conditions of relative humidity and temperature as shown in Table 10. The membrane samples were measured for thickness after the conductivity measurements and used in their calculation. The conductivity values are inferior to those of the sample pressed at 225° C. in Example 6 and the sample pressed at 200° C. in Example 8.

TABLE 10

| | |
|---|---|
| Heat- | In-Plane |
| Treatment | Conductivity |

| Temperature | Relative | 80° C. | 120° C. | Thickness |
|---|---|---|---|---|
| ° C. | Humidity % | mS/cm | mS/cm | microns |
| 225° C. | 25 | 4.2 | 10.8 | 44 |
| | 50 | 28.2 | 48.0 | |
| | 95 | 182.7 | 215.8 | |

What is claimed is:

1. A method for conditioning a proton exchange membrane comprising the steps of:
a) providing a fully hydrated membrane comprising a fluorinated sulfonic acid polymer;
b) placing the membrane in a sealed container;
c) heating the membrane to a membrane conditioning temperature greater than about 120° C. and applying a membrane conditioning pressure to the membrane while the membrane is heated to the membrane conditioning temperature, the membrane conditioning pressure being above the steam pressure for the membrane conditioning temperature;
d) cooling the membrane while maintaining the membrane conditioning pressure; and
e) releasing the membrane conditioning pressure when the membrane temperature is below about 100° C.

2. The method of claim 1 wherein the fully hydrated membrane is hydrated by soaking the membrane in an aqueous solution.

3. The method of claim 2 wherein the aqueous solution is acidic water that is above about 60° C.

4. The method of claim 1 wherein the fluorinated sulfonic acid polymer comprises a perfluorinated backbone containing pendant groups described by the formula —(O—CF₂CFR_{f})ₐ—(O—CF₂)_{b}—(CFR′_{f})_{c}SO₃OH, where R_{f} and R′_{f} are independently selected from F, Cl or a perfluorinated alkyl group having 1 to 10 carbon atoms, a=0 to 2, b=0 to 1, and c=0 to 6.

5. The method of claim 4 wherein the fluorinated sulfonic acid polymer comprises sulfonic acid pendant groups derived from pendant groups of the formula —O—CF₂CF(CF₃)—O—CF₂CF₂SO₂F or —OCF₂CF₂SO₂F.

6. The method of claim 1 wherein in step c), the membrane conditioning pressure is above the steam pressure for the membrane conditioning temperature for at least 2 minutes while the membrane temperature is greater than about 120° C.

7. The method of claim 1 wherein in step c) the membrane conditioning pressure is greater than about 200 KPa.

8. The method of claim 1 wherein in step c) the membrane conditioning temperature is greater than about 150° C. and the membrane conditioning pressure is greater than about 475 KPa.

9. The method of claim 1 wherein the pressure on the membrane is applied by direct pressure.

10. The method of claim 1 wherein in step c) the membrane conditioning pressure is applied to the membrane before the membrane is heated to the membrane conditioning temperature greater than about 120° C.

11. The method of claim 1 wherein the membrane further comprises a catalyst applied on at least one side of the membrane to form a catalyst coated membrane.

12. The method of claim 1 wherein the membrane further comprises a catalyst applied on both sides of the membrane to form a catalyst coated membrane.

13. The method of claim 1 wherein in step c) a catalyst is applied as a decal on at least one side of the membrane to form a catalyst coated membrane.

14. The method of claim 1 wherein the membrane further comprises a gas diffusion electrode on at least one side of the membrane.

15. The method of claim 1 wherein the membrane further comprises a gas diffusion electrode on both sides of the membrane.

16. The method of claim 1 wherein in step c) a gas diffusion electrode is applied on at least one side of the membrane.

17. The method of claim 1 wherein the membrane is a component of a membrane electrode assembly.
